(19) United States
(12) Patent Application Publication
(10) Pub. No.: US 2026/0178633 A1
(43) Pub. Date: Jun. 25, 2026

(54) INFORMATION RETRIEVAL METHOD AND DEVICE

(71) Applicant: Alipay (Hangzhou) Digital Service Technology Co., Ltd., Hangzhou (CN)

(72) Inventors: Mingyao LI, Hangzhou (CN); Yongchao LIU, Hangzhou (CN); Yice LUO, Hangzhou (CN); Likang CHEN, Hangzhou (CN); Chuntao HONG, Hangzhou (CN)

(21) Appl. No.: 19/416,399

(22) Filed: Dec. 11, 2025

(30) Foreign Application Priority Data
Dec. 25, 2024 (CN) 202411934990.6

(51) Int. Cl. G06F 16/334; G06F 16/901; G06F 40/295

(52) U.S. Cl. CPC G06F 16/3344; G06F 16/9024; G06F 40/295

(57) ABSTRACT

An information retrieval method includes: obtaining a query text used to trigger information retrieval, and performing named entity recognition on the query text to recognize an entity word from the query text as a retrieval entity word; calculating an association degree of each candidate entity word relative to the retrieval entity word based on a graph; determining a predetermined quantity of candidate entity words with a highest association degree relative to the retrieval entity word as associated entity words, and calculating an association degree of each candidate document relative to the query text based on association degrees of the associated entity words relative to the retrieval entity word; and determining a predetermined quantity of candidate documents with a highest association degree relative to the query text as associated documents, and determining the associated documents as an information retrieval result corresponding to the query text.

### CROSS-REFERENCE TO RELATED APPLICATIONS

This application is based upon and claims priority to Chinese Patent Application No. 202411934990.6, filed on Dec. 25, 2024, the entire content of which is incorporated herein by reference.

### TECHNICAL FIELD

Embodiments of this specification relate to the field of artificial intelligence technologies, and in particular, to an information retrieval method and device.

### BACKGROUND

Information retrieval (IR) focuses on finding information related to user queries from a large quantity of documents or data sets. A conventional information retrieval system primarily depends on keyword matching and text similarity-based algorithms to provide information retrieval results. However, this manner shows significant inadequacies in many aspects such as complex and multi-entity-related queries (for example, queries involving a plurality of entities).

### SUMMARY

According to a first aspect of this specification, an information retrieval method includes: obtaining a query text used to trigger information retrieval, performing named entity recognition on the query text to recognize an entity word from the query text, and determining the entity word recognized from the query text as a retrieval entity word; calculating an association degree of each candidate entity word relative to the retrieval entity word based on a graph, where each node in the graph represents each candidate entity word, and there is an association relationship between candidate entity words represented by nodes connected by each edge in the graph; determining a predetermined quantity of candidate entity words with a highest association degree relative to the retrieval entity word as associated entity words, and calculating an association degree of each candidate document relative to the query text based on association degrees of the associated entity words relative to the retrieval entity word; and determining a predetermined quantity of candidate documents with a highest association degree relative to the query text as associated documents, and determining the associated documents as an information retrieval result corresponding to the query text.

According to a second aspect of this specification, an information retrieval device includes: a processor; and a storage configured to store processor-executable instructions, wherein the processor is configured to: obtain a query text used to trigger information retrieval, perform named entity recognition on the query text to recognize an entity word from the query text, and determine the entity word recognized from the query text as a retrieval entity word; calculate an association degree of each candidate entity word relative to the retrieval entity word based on a graph, where each node in the graph represents each candidate entity word, and there is an association relationship between candidate entity words represented by nodes connected by each edge in the graph; determine a predetermined quantity of candidate entity words with a highest association degree relative to the retrieval entity word as associated entity words, and calculate an association degree of each candidate document relative to the query text based on association degrees of the associated entity words relative to the retrieval entity word; and determine a predetermined quantity of candidate documents with a highest association degree relative to the query text as associated documents, and determine the associated documents as an information retrieval result corresponding to the query text.

According to a second aspect of this specification, a non-transitory computer-readable storage medium stores instructions that, when executed by a processor, cause the processor to perform the information retrieval method in the first aspect.

### BRIEF DESCRIPTION OF DRAWINGS

The following describes the accompanying drawings to be used in the descriptions of example embodiments.

FIG. 1 is a schematic diagram of an information retrieval system according to an example embodiment.

FIG. 2 is a schematic diagram of an information retrieval procedure according to an example embodiment.

FIG. 3 is a flowchart of a graph construction method according to an example embodiment.

FIG. 4A is a schematic diagram of a graph according to an example embodiment.

FIG. 4B is a schematic diagram of another graph according to an example embodiment.

FIG. 4C is a schematic diagram of another graph according to an example embodiment.

FIG. 5 is a flowchart of an information retrieval method according to an example embodiment.

FIG. 6 is a schematic diagram of an information retrieval device according to an example embodiment.

FIG. 7 is a block diagram of an information retrieval apparatus according to an example embodiment.

### DETAILED DESCRIPTION OF EMBODIMENTS

Example embodiments are described in detail herein, and examples of the example embodiments are presented in the accompanying drawings. When the following descriptions relate to the accompanying drawings, unless specified otherwise, same numbers in different accompanying drawings represent same or similar elements. Implementations described in the following example embodiments do not represent all implementations consistent with embodiments of this specification. On the contrary, the implementations are merely examples consistent with some aspects of one or more embodiments of this specification.

It should be noted that in some embodiments, steps in a corresponding method are not necessarily performed based on a sequence shown and described in this specification. In some embodiments, the method can include more or fewer steps than those described in this specification. In addition, a single step described in this specification may be split into a plurality of steps in some embodiments; and a plurality of steps described in this specification may be combined into a single step in some embodiments.

With development of the Internet and an explosive increase in a data volume, there is an increasing requirement for information retrieval, and information retrieval is increasingly widely applied.

For example, a user can actively initiate real-time information retrieval to obtain information currently required.

For another example, an intelligent dialogue system can provide a service to a user through retrieval-augmented generation (RAG) and with reference to information retrieval and model generation.

The intelligent dialogue system provides a service to the user by simulating human communication. Specifically, the intelligent dialogue system is an interactive system developed by using an artificial intelligence technology, and is intended to understand and answer a question raised by the user in a natural language form, and generate a concise and clear answer. The intelligent dialogue system is usually based on a large language model. The large language model understands and answers a question raised by the user, and generates a corresponding answer.

The large language model is a deep learning model trained by using a large amount of text data, and can be used to generate a natural language text or understand a meaning of a natural language text. The large language model can process a plurality of natural language tasks, for example, text classification, named entity recognition (NER), question answering, and dialogues, and is an important approach to artificial intelligence.

In the field of natural language processing, a large-scale text data set is usually referred to as a corpus. The corpus can include various types of text data, for example, literary works, academic papers, legal documents, news reports, daily dialogues, emails, and web forum posts. By learning from the text data in the corpus, the large language model can obtain and understand a rule and a pattern of a natural language, thereby implementing effective processing and generation of a human language.

The large language model usually uses a transformer architecture, that is, the large language model is usually a deep learning model based on the transformer architecture. The deep learning model based on the transformer architecture is a class of neural network models using the transformer architecture. Such a model performs excellently in fields such as natural language processing.

A transformer is a neural network model for sequence-to-sequence modeling. The transformer does not need to depend on a recursive structure, and can parallelize training and inference, accelerating a model processing speed. In the deep learning model based on the transformer architecture, a multi-layer transformer encoder is usually used to extract features from an input sequence, and a transformer decoder is used to convert the extracted features into an output sequence. In addition, in such a model, a self-attention mechanism is usually used to capture a long-range dependency in the input sequence, and a residual connection and a regularization method are used to accelerate training and improve model performance.

A pre-trained model is a large language model pre-trained on large-scale unlabeled text data. The pre-trained model is a general model and is not designed and optimized for a specific task. To enable the pre-trained model to adapt to a specific application scenario and task requirement, fine-tuning needs to be performed to improve performance of the model in a specific task. A large language model that is finally put into use is usually a model obtained by performing further fine-tuning based on the pre-trained model and performing supervised learning based on labeled text data. Pre-training and fine-tuning are complementary processes. Pre-training enables the model to have an extensive language understanding capability, while fine-tuning makes the model more professional and accurate in a specific task.

That is, a training process of the large language model can be divided into two phases: pre-training and fine-tuning. In the pre-training phase, pre-training can be performed on a large-scale unlabeled text data set (for example, network encyclopedia, network articles, and books) through unsupervised learning (for example, self-supervised learning). Specifically, a missing part or a next word can be predicted based on context, a statistical rule and a language structure such as semantics and syntax can be learned, and backpropagation and optimization algorithms (for example, a gradient descent method) can be used to minimize a prediction loss and iteratively update a model parameter, to gradually improve a language understanding capability of the model. In the fine-tuning phase, a corresponding supervised learning task (for example, text classification, named entity recognition, a question-answering system, or a dialogue system) can be selected based on a specific application scenario and task requirement, and a task-specific text data set is prepared. Therefore, the pre-trained model can be used as a start point for fine-tuning, and fine-tuning can be performed on the task-specific text data set through supervised learning. Specifically, the task can be executed based on the text data set, and the backpropagation and optimization algorithms (for example, the gradient descent method) can be used to minimize a loss used to measure performance of the model in processing a specific task and iteratively update the model parameter, to gradually improve the performance of the model in the specific task. In some embodiments, supervised learning, unsupervised learning, or semi-supervised learning can be flexibly selected for fine-tuning based on a specific application scenario and a type of available data.

It should be noted that the pre-trained large language model is usually referred to as a foundation model of the large language model, and the fine-tuned large language model is referred to as a service model of the large language model. The language understanding capability learned by the large language model in the pre-training phase and the fine-tuning phase enables the large language model to understand, analyze, and combine text information to perform logical inference or knowledge inference, or resolve problems when facing complex problems or tasks. Such a capability is usually referred to as an inference capability of the large language model.

The large language model usually executes a specific task under guidance of a prompt text (which can be referred to as a prompt). The prompt text is an initial text or a text segment provided to the large language model to stimulate the model to generate a corresponding output. The prompt text can be used to clearly notify the large language model of a task that the large language model is expected to execute, for example, answering a question, simulating a dialogue, writing an article, or translating a text. In addition, the prompt text can provide necessary background information and context to the large language model, so that the large language model can understand logic, a style, a subject, or a position that should be followed when content is generated. Moreover, the prompt text can further stimulate the large language model to display its inherent knowledge reserve or specific language capability, for example, explaining complex concepts, citing regulations, or imitating a writing style of a specific writer.

The intelligent dialogue system primarily depends on the knowledge obtained by the large language model by learning the static corpus in the training process. Due to limitations of the knowledge, the system may have a hallucination problem when answering complex or specific questions. The hallucination problem means that content generated by the large language model seems very proper and coherent, and sometimes can imitate human emotions and ways of thinking, creating an illusion of “understanding” input content. However, actually, the content is inaccurate or misleading. That is, this dependence on the static corpus limits adaptability and response accuracy of the intelligent dialogue system.

To improve the adaptability and the response accuracy of the intelligent dialogue system, a retrieval-augmented generation (RAG) manner can be used, and information retrieval and model generation can be combined, so that when answering a question raised by a user, the intelligent dialogue system no longer depends on the knowledge obtained by the large language model by learning the static corpus in the training process, but can first perform information retrieval in a large-scale document set based on the question, then understand and answer the question based on a retrieved related document, and generate a corresponding answer. That is, the document set can be combined with the large language model. In a model generation process, related information is retrieved in real time from the document set, to assist the model in making a more accurate and comprehensive answer or decision. Because the retrieved information and context of the question are considered in the model generation process, it can be ensured that generated content meets an actual requirement, and is accurate, reliable, coherent, and natural.

For information retrieval, a conventional information retrieval system primarily depends on keyword matching and text similarity-based algorithms to provide information retrieval results. However, this manner shows significant inadequacies in many aspects such as complex and multi-entity-related queries.

To cope with complex queries and multi-entity-related queries in an information retrieval process, information retrieval can be implemented with reference to a graph.

In the graph, data is stored and managed in a graphical structure. In the graph, a node, an edge, and a property are used to store data. This storage manner is very suitable for expressing a complex relationship between entities. In the graph, the node represents an entity, for example, a person, a location, or an event. Each node can have a plurality of properties to describe specific information about the entity. The edge is used to represent a relationship between nodes, for example, “knows”, “belongs to”, or “located in”. The edge can also include a property to describe a characteristic of the relationship, for example, strength and an establishment time of the relationship. The property is a data field attached to the node or the edge and used to store specific information, for example, a name or an age of a person, or a start date of a relationship.

When information retrieval is implemented with reference to a graph, entities and a relationship between the entities can be captured by using the graph. For complex queries or queries involving a plurality of entities and interaction between the entities, more accurate and context-related information retrieval results can be provided.

Embodiments of this specification provide a technical solution for implementing information retrieval. In this technical solution, a graph used for information retrieval can be pre-constructed. Each node in the graph represents a candidate entity word, and each edge is used to indicate that there is an association relationship between candidate entity words represented by connected nodes. Subsequently, when a query text used to trigger information retrieval is obtained, named entity recognition can be first performed on the query text to recognize a retrieval entity word from the query text. Then, an association degree of each candidate entity word relative to the retrieval entity word can be calculated based on the constructed graph. Then, several candidate entity words with a highest association degree relative to the retrieval entity word can be determined as associated entity words, and an association degree of each candidate document relative to the query text can be calculated based on association degrees of the associated entity words relative to the retrieval entity word. Finally, several candidate documents with a highest association degree relative to the query text can be determined as associated documents, and the associated documents can be determined as an information retrieval result corresponding to the query text.

In the above manner, information retrieval is implemented with reference to a graph. Entity words in a retrievable document and an association relationship between the entity words can be captured by using the graph. Therefore, when a document is retrieved based on an entity word included in a query text, this can ensure that an information retrieval result is more accurate, and achieves stronger pertinence than an original query. In addition, the graph can be pre-constructed, so that the constructed graph can be directly used in a subsequent information retrieval process, to improve efficiency of implementing information retrieval with reference to the graph.

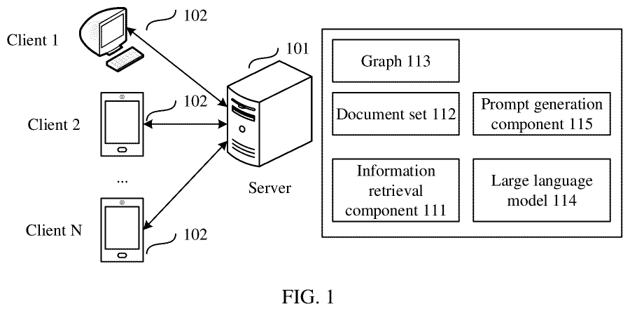

FIG. 1 is a schematic diagram of an information retrieval system according to an example embodiment of this specification. As shown in FIG. 1, the system can include a server 101 and at least one client 102 that accesses the server 101 by using any type of wired or wireless network.

The server 101 can correspond to a server that includes one independent physical host, can be a server cluster that includes a plurality of independent physical hosts, or can correspond to a virtual server, a cloud server, etc. carried by a host cluster.

The client 102 can correspond to a terminal device such as a smartphone, a tablet computer, a notebook computer, a desktop computer, a personal computer (PC), a personal digital assistant (PDA), a wearable device (for example, smart glasses or a smartwatch), a smart vehicle-mounted device, or a game console.

A user can use, by using the client 102, an information retrieval service provided by the information retrieval system. The client 102 and the server 101 can implement the user-oriented information retrieval service through data exchange between each other.

For example, the client 102 can output a specific user interface to the user, so that the user can perform operations such as entering a query text (which can be referred to as a query) and selecting an information retrieval range (for example, a document set in a specific field) in the user interface, to initiate a query to the information retrieval system, and use the information retrieval service provided by the information retrieval system. The client 102 can send the query text entered by the user to the server 101. The server 101 performs, based on the query text, information retrieval in a document set provided on the server 101, to obtain a corresponding information retrieval result (for example, a retrieved document), and outputs the information retrieval result to the user. That is, the information retrieval result is returned to the client 102, and the client 102 displays the information retrieval result to the user through the user interface for viewing by the user, thereby implementing the user-oriented information retrieval service.

For example, referring to FIG. 1, an information retrieval component 111 can be provided on the server 101, and the information retrieval component performs the operation of performing, based on the query text, information retrieval in a document set 112 provided on the server 101. In addition, a graph 113 corresponding to the document set 112 can be further provided on the server 101, so that the information retrieval component 111 can use the graph to perform information retrieval.

Still referring to FIG. 1, the system shown in FIG. 1 can alternatively be an intelligent dialogue system that can provide an information retrieval-related service. A user can use, by using the client 102, an intelligent dialogue service provided by the intelligent dialogue system. The client 102 and the server 101 can implement the user-oriented intelligent dialogue service through data exchange with each other.

For example, the client 102 can output a corresponding user interface to the user, so that the user can perform operations such as entering a query text (which can be referred to as a query or a question) and uploading a document for assisting in a query in the user interface, to raise a question to the intelligent dialogue system, and use the intelligent dialogue service provided by the intelligent dialogue system. The client 102 can send the query text entered by the user to the server 101. The server 101 performs inference for the query text, to generate a corresponding answer text (which can be referred to as an answer), and outputs the answer text to the user. That is, the answer text is returned to the client 102, and the client 102 displays the answer text to the user through the user interface for viewing by the user, thereby implementing the user-oriented intelligent dialogue service.

For example, referring to FIG. 1, a large language model 114 can be provided on the server 101. The intelligent dialogue system can be based on the large language model 114, and the large language model 114 understands and answers the query text entered by the user, and generate an answer text corresponding to the query text.

In this case, the large language model can be a service model of the large language model. In some embodiments, for the constructed large language model, pre-training can be performed on large-scale unlabeled text data through unsupervised learning, to obtain a foundation model of the large language model. Further, a dialogue task can be used as a supervised learning task during fine-tuning, and a text data set specific to the dialogue task is prepared, so that the foundation model of the large language model can be used as a start point of fine-tuning, and fine-tuning is performed on the text data set specific to the dialogue task through supervised learning, to obtain the service model of the large language model.

To improve adaptability and response accuracy of the intelligent dialogue system, a document set and an information retrieval component can be further provided on the server 101. In an inference process of the service model of the large language model, the information retrieval component performs information retrieval in the document set based on the query text, to assist, by using a retrieved related document, the service model of the large language model in generating an answer text corresponding to the query text entered by the user. In addition, a graph corresponding to the document set can be further provided on the server 101, so that the information retrieval component can use the graph to perform information retrieval.

In some embodiments, another functional component or functional subsystem such as a prompt generation component 115 can be further provided on the server 101. The component or subsystem can work together with the large language model provided on the server 101, to jointly generate an answer text corresponding to the query text entered by the user.

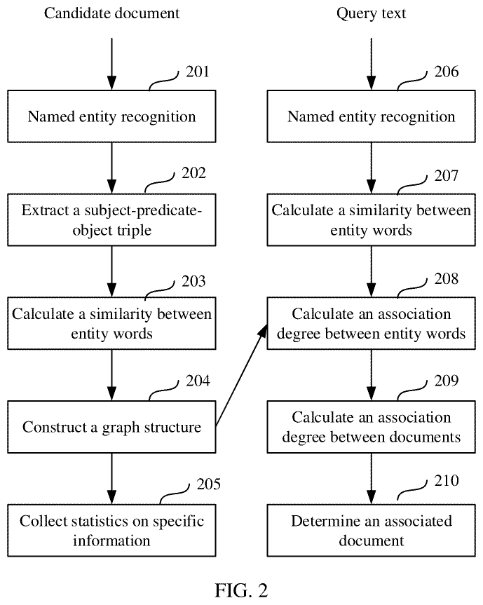

FIG. 2 is a schematic diagram of an information retrieval procedure according to an example embodiment of this specification.

As shown in FIG. 2, in the information retrieval procedure, to improve efficiency of implementing information retrieval with reference to a graph, a graph that facilitates information retrieval can be pre-constructed, and subsequently, the constructed graph can be directly used in an information retrieval process. Each node in the graph represents each candidate entity word, and there is an association relationship between candidate entity words represented by nodes connected by each edge in the graph. It should be noted that the graph can be constructed offline, and information retrieval is performed online by using the constructed graph.

When the graph is constructed, candidate documents can be first obtained, and named entity recognition (201) is performed on each candidate document to recognize an entity word from each candidate document. Then, a subject-predicate-object triple can be extracted (202) from each candidate document based on entity words recognized from these candidate documents, and entity words in each subject-predicate-object triple can be determined as entity words with an association relationship. Then, the entity words recognized from these candidate documents and entity words in these subject-predicate-object triples can be determined as candidate entity words. In addition, a similarity between each target candidate entity word and each of other candidate entity words in these candidate entity words can be further calculated (203), and several candidate entity words with a highest similarity can be determined as candidate entity words that have an association relationship with the target candidate entity word. Finally, the graph can be constructed (204) based on these candidate entity words and an association relationship between the candidate entity words.

In addition, statistics on some specific information can be further collected (205) for the candidate document. For example, a quantity of occurrences of each candidate entity word in each candidate document can be counted, and a correspondence between the candidate entity word, the candidate document, and the quantity of occurrences of the candidate entity word in the candidate document can be stored.

When information retrieval is performed by using the constructed graph, first, a query text used to trigger information retrieval can be obtained, named entity recognition (206) can be performed on the query text to recognize an entity word from the query text, and the entity word recognized from the query text can be determined as a retrieval entity word. In addition, a similarity between the entity word recognized from the query text and each candidate entity word can be further calculated (207), and several candidate entity words with a highest similarity can also be determined as retrieval entity words. Then, an association degree of each candidate entity word relative to each retrieval entity word can be calculated (208) based on the constructed graph, and several candidate entity words with a highest association degree relative to each retrieval entity word can be determined as associated entity words. Then, an association degree of each candidate document relative to the query text can be calculated (209) based on an association degree of each associated entity word relative to each retrieval entity word. Finally, one or more candidate documents with a highest association degree relative to the query text can be determined (210) as associated documents, and these associated documents can be determined as an information retrieval result corresponding to the query text.

The information retrieval method provided in this specification is further described below in detail from two aspects: construction and use of a graph.

### I. Construction of a Graph

First, it should be noted that in the constructed graph, one node can represent one entity word (which can be referred to as a candidate entity word), and the entity word is a word used to represent a specific or abstract entity; and one edge can connect two nodes, and the edge is used to indicate that there is an association relationship between candidate entity words respectively represented by the two nodes connected by the edge. For example, if one edge in the graph connects a node A and a node B, the node A represents a candidate entity word A, and the node B represents a candidate entity word B, the edge is used to indicate that there is an association relationship between the candidate entity word A and the candidate entity word B.

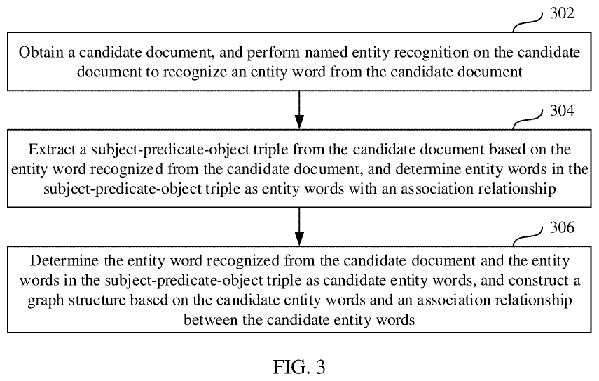

FIG. 3 is a flowchart of a graph construction method according to an example embodiment of this specification. As shown in FIG. 3, the graph construction method can include the following steps.

Step 302: Obtain a candidate document, and perform named entity recognition on the candidate document to recognize an entity word from the candidate document.

In this embodiment, one or more documents (which can be referred to as candidate documents) used to construct a graph can be obtained. It should be noted that when a graph is constructed based on these candidate documents, the graph should be subsequently used in these candidate documents to perform information retrieval. Otherwise, a problem of inconsistent document information may occur, resulting in a failure in information retrieval. For example, if these candidate documents are from a certain corpus, after the graph is constructed based on these candidate documents, if information retrieval is to be performed by using the graph, the corpus needs to be set to an information retrieval range, that is, information retrieval needs to be performed in the candidate document included in the corpus.

When the candidate document is obtained, named entity recognition can be performed on each candidate document to recognize a named entity from each candidate document. Because the named entity is an entity word, the named entity recognized through named entity recognition can be directly determined as an entity word.

In some embodiments, named entity recognition can be performed on the candidate document by using a large language model. Specifically, each candidate document can be input into the large language model, so that the large language model performs named entity recognition on each candidate document.

In this case, the large language model can be a service model of the large language model. In some embodiments, for the constructed large language model, pre-training can be performed on large-scale unlabeled text data through unsupervised learning, to obtain a foundation model of the large language model. Further, a named entity recognition task can be used as a supervised learning task during fine-tuning training, and a text data set specific to the named entity recognition task is prepared, so that the foundation model of the large language model can be used as a start point of fine-tuning, and fine-tuning training is performed on the text data set specific to the named entity recognition task through supervised learning, to obtain the service model of the large language model.

Step 304: Extract a subject-predicate-object triple from the candidate document based on the entity word recognized from the candidate document, and determine entity words in the subject-predicate-object triple as entity words with an association relationship.

In this embodiment, when the entity word is recognized from the candidate document, the subject-predicate-object triple can be further extracted from each candidate document based on the entity word.

The subject-predicate-object triple is a concept commonly used in fields such as natural language processing, information extraction, and knowledge graphs, and is used to represent a basic semantic structure in a sentence. A typical subject-predicate-object triple includes three parts: a subject(S), a predicate (P), and an object (O). The subject is an entity that performs an action or is described. The predicate represents an action or a state of the subject, and usually includes a verb. The object is an entity that accepts the action.

For the subject-predicate-object triple, both the subject and the object are entities, and the predicate usually can be considered as a relationship between the two entities. Therefore, when the subject-predicate-object triple is extracted from the candidate document, entity words (usually a subject and an object) in each subject-predicate-object triple can be determined as entity words with an association relationship.

A sentence “Xiaoming ate an apple” is used as an example. In a subject-predicate-object triple extracted from this sentence, the subject is “Xiaoming”, the predicate is “ate”, and the object is “an apple”. In this case, “Xiaoming” and “an apple” can be determined as two entity words, and the two entity words can be determined as two entity words with an association relationship.

In some embodiments, the subject-predicate-object triple can be extracted from the candidate document by using an open information extraction (OpenIE) technology. OpenIE is an information extraction technology that is intended to automatically extract factual statements from unlabeled texts and represent the statements as structured triple forms (usually subject-predicate-object).

In some embodiments, the subject-predicate-object triple can be extracted from each candidate document by using a large language model based on the entity word recognized from the candidate document. Specifically, the entity words recognized from these candidate documents and each candidate document can be input into the large language model, so that the large language model extracts the subject-predicate-object triple from each candidate document based on the entity words recognized from these candidate documents.

In this case, the large language model can be a service model of the large language model. In some embodiments, for the constructed large language model, pre-training can be performed on large-scale unlabeled text data through unsupervised learning, to obtain a foundation model of the large language model. Further, a triple extraction task can be used as a supervised learning task during fine-tuning training, and a text data set specific to the triple extraction task is prepared, so that the foundation model of the large language model can be used as a start point of fine-tuning, and fine-tuning training is performed on the text data set specific to the triple extraction task through supervised learning, to obtain the service model of the large language model.

It should be noted that extracting the subject-predicate-object triple from these candidate documents based on the entity word recognized from the candidate document can ensure that extracted information is as comprehensive as possible, thereby reducing information omissions. This is because these entity words are essentially named entities with specific meanings. The named entity is usually a most important information carrier in a sentence, can be used to quickly locate core content in a text, and also helps accurately determine a subject and an object in the sentence. A relationship between named entities is usually a most critical part in the sentence. Constructing a subject-predicate-object triple based on the named entity can make information extraction more centralized and targeted, avoid inaccurate information extraction due to ambiguity or incorrect parsing, and better capture a relationship between entities to ensure integrity of information extraction. In addition, for a sentence that includes a plurality of clauses or a complex structure, it is relatively difficult to directly extract a subject-predicate-object triple. However, the named entity can provide a reliable start point to help parse a complex sentence structure, so as to understand a meaning of a sentence more comprehensively and correctly extract information.

In some embodiments, to improve processing efficiency and accuracy of the candidate document, the original candidate document can be first cleaned, and then processing such as named entity recognition and extraction of a subject-predicate-object triple can be performed on the cleaned candidate document. The cleaning operation can specifically include operations such as de-duplication, long text segmentation, and unrelated word removal.

Step 306: Determine the entity word recognized from the candidate document and the entity words in the subject-predicate-object triple as candidate entity words, and construct a graph based on the candidate entity words and an association relationship between the candidate entity words.

In this embodiment, the entity word recognized from the candidate document and the entity words in the subject-predicate-object triples extracted from these candidate documents can be determined as candidate entity words, and it can be further determined, based on entity words with an association relationship in these entity words, whether there is an association relationship between these candidate entity words. In this way, the graph can be constructed based on these candidate entity words and an association relationship between the candidate entity words. For example, one node in the graph represents one candidate entity word, and one edge in the graph is used to indicate that there is an association relationship between candidate entity words respectively represented by two nodes connected by the edge.

It should be noted that there may be a duplicate part between the entity word recognized from the candidate document and the entity words in the subject-predicate-object triples extracted from these candidate documents. Therefore, when these entity words are determined as the candidate entity words, de-duplication processing can be performed on these entity words, so that the determined candidate entity words are different from each other, and each of the candidate entity words is unique.

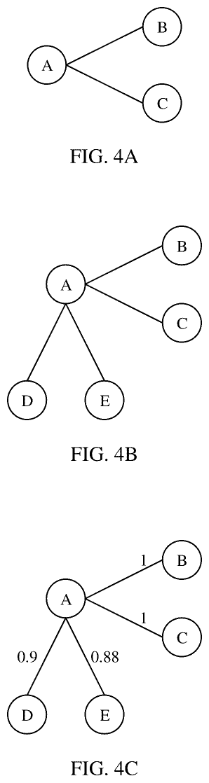

For example, if the entity word recognized from the candidate document includes an entity word A and an entity word B, and the entity words in the subject-predicate-object triples extracted from these candidate documents include the entity word A, the entity word B, and an entity word C, the entity word A, the entity word B, and the entity word C can be respectively determined as a candidate entity word A, a candidate entity word B, and a candidate entity word C. Further, if the entity word A and the entity word B belong to a same subject-predicate-object triple, and the entity word A and the entity word C belong to a same subject-predicate-object triple, that is, the entity word A and the entity word B are entity words with an association relationship, and the entity word A and the entity word C are entity words with an association relationship, it can be determined that there is an association relationship between the candidate entity word A and the candidate entity word B, and there is an association relationship between the candidate entity word A and the candidate entity word C. In this case, the constructed graph can be shown in FIG. 4A in which a node A, a node B, and a node C respectively represent the candidate entity word A, the candidate entity word B, and the candidate entity word C, the node A and the node B are connected by one edge, and the node A and the node C are also connected by one edge.

In some embodiments, to construct a richer graph and make a relationship between different entity words clearer, another entity word similar to each named entity can be found, and the graph is constructed based on the similar entity word. For example, each of the candidate entity words can be used as a target candidate entity word, a similarity between the target candidate entity word and each of other candidate entity words can be calculated, and a predetermined quantity (that is, top K) of candidate entity words with a highest similarity can be determined as candidate entity words that have an association relationship with the target candidate entity word.

In some embodiments, a similarity between different entity words can be calculated by using a word embedding technology. For example, when a similarity between the target candidate entity word (assumed as the candidate entity word A) and any other candidate entity word (assumed as the candidate entity word B) is calculated, embedding processing can be separately performed on the candidate entity word A and the candidate entity word B to obtain embedding vectors respectively corresponding to the candidate entity word A and the candidate entity word B, so that a similarity between the embedding vector corresponding to the candidate entity word A and the embedding vector corresponding to the candidate entity word B can be calculated as the similarity between the candidate entity word A and the candidate entity word B.

In some embodiments, the top K candidate entity words with a highest similarity to the target candidate entity word can be conveniently determined by using a K-nearest neighbor algorithm.

The example shown in FIG. 4A is still used as an example. If two candidate entity words with a highest similarity to the candidate entity word A are a candidate entity word D and a candidate entity word E, a similarity between the candidate entity word A and the candidate entity word D is 90%, and a similarity between the candidate entity word A and the candidate entity word E is 88%, it can be determined that there is an association relationship between the candidate entity word A and the candidate entity word D, and there is an association relationship between the candidate entity word A and the candidate entity word E. In this case, the constructed graph can be shown in FIG. 4B in which a node A, a node B, a node C, a node D, and a node E respectively represent the candidate entity word A, the candidate entity word B, the candidate entity word C, the candidate entity word D, and the candidate entity word E, the node A and the node B are connected by one edge, the node A and the node C are connected by one edge, the node A and the node D are connected by one edge, and the node A and the node E are also connected by one edge.

In some embodiments, to make a relationship between different entity words clearer, a corresponding weight can be further set for each edge in the constructed graph. In the graph, if nodes representing candidate entity words that belong to a same subject-predicate-object triple are referred to as first-type nodes, and nodes representing candidate entity words that are similar candidate entity words are referred to as second-type nodes, a weight for an edge used to connect the first-type nodes can be a predetermined value, and a weight for an edge used to connect the second-type nodes can be a similarity between the candidate entity words represented by the second-type nodes.

The example shown in FIG. 4A and FIG. 4B is still used as an example. Because the candidate entity word A and the candidate entity word B belong to the same subject-predicate-object triple, and the candidate entity word A and the candidate entity word C belong to the same subject-predicate-object triple, a weight for the edge used to connect the node A and the node B can be set to 1, and a weight for the edge used to connect the node A and the node C can also be set to 1. Because the similarity between the candidate entity word A and the candidate entity word D is 90%, and the similarity between the candidate entity word A and the candidate entity word E is 88%, a weight for the edge used to connect the node A and the node D can be set to 0.9, and a weight for the edge used to connect the node A and the node E can be set to 0.88. In this case, the constructed graph can be shown in FIG. 4C.

It should be noted that the edge in the graph usually can be an undirected edge. However, in some embodiments, to better represent a relationship between the candidate entity words, the edge in the graph can alternatively be a directed edge. This is not limited in this specification.

In addition, construction logic of the graph can be flexibly adjusted based on an actual requirement. For example, some candidate entity words that are relatively critical in an application scenario can be selected based on an actual requirement, and a quantity of determined other candidate entity words that are similar to the candidate entity words can be adjusted, to adjust an in-degree/out-degree of a node that represents the candidate entity word in the constructed graph (that is, a quantity of edges connecting the node).

In some embodiments, to further improve efficiency of information retrieval, statistics on some specific information can be collected for the candidate document. For example, a quantity of occurrences of each candidate entity word in each candidate document can be counted, and a correspondence between the candidate entity word (which can be a unique identifier of the candidate entity word), the candidate document (which can be a unique identifier of the candidate document), and the quantity of occurrences of the candidate entity word in the candidate document can be stored, as shown in Table 1 below.

TABLE 1

| | | Quantity of |
|---|---|---|
| Candidate entity word | Candidate document | occurrences |
| Candidate entity word A | Candidate document 1 | 18 |
| Candidate entity word B | Candidate document 1 | 26 |
| Candidate entity word A | Candidate document 2 | 12 |
| . . . | . . . | . . . |

### II. Use of a Graph

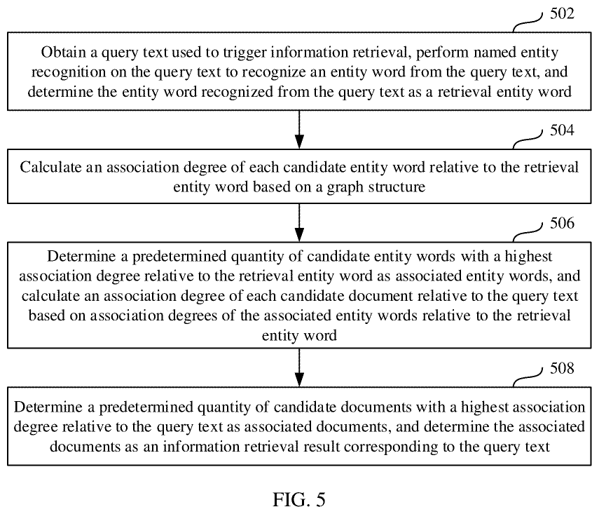

FIG. 5 is a flowchart of an information retrieval method according to an example embodiment of this specification. As shown in FIG. 5, the information retrieval method can include the following steps.

Step 502: Obtain a query text used to trigger information retrieval, perform named entity recognition on the query text to recognize an entity word from the query text, and determine the entity word recognized from the query text as a retrieval entity word.

In this embodiment, a query text used to trigger information retrieval can be obtained. When the query text is obtained, named entity recognition can be performed on the query text to recognize an entity word from the query text. It should be noted that the entity word recognized from the query text can be used as a retrieval entity word for subsequent information retrieval.

In some embodiments, named entity recognition can be performed on the query text by using a large language model. For example, the query text can be input into the large language model, so that the large language model performs named entity recognition on the query text.

In this case, the large language model can be a service model of the large language model. It should be noted that to ensure consistency of recognized named entities and facilitate implementation of information retrieval, the large language model and the large language model used to perform named entity recognition on the candidate document can be a same large language model.

In some embodiments, although the named entity recognized from the query text can reflect a primary intent of the query, the named entity may be insufficient to fully cover an underlying meaning of the query. Therefore, to extend a semantic range of the query and improve accuracy of information retrieval, another entity word similar to each named entity can be found, and the similar entity word is also determined as a retrieval entity word. For example, for an entity word recognized from the query text, a similarity between the entity word and each candidate entity word can be used, and a predetermined quantity (that is, top K) of candidate entity words with a highest similarity are also used.

In some embodiments, when a similarity between any entity word (assumed as an entity word A) recognized from the query text and any candidate entity word (assumed as a candidate entity word B) is calculated, embedding processing can be separately performed on the entity word A and the candidate entity word B to obtain embedding vectors respectively corresponding to the entity word A and the candidate entity word B, so that a similarity between the embedding vector corresponding to the entity word A and the embedding vector corresponding to the candidate entity word B can be calculated as the similarity between the entity word A and the candidate entity word B.

In some embodiments, top K candidate entity words with a highest similarity to each entity word recognized from the query text can be conveniently determined by using a K-nearest neighbor algorithm.

Step 504: Calculate an association degree of each candidate entity word relative to the retrieval entity word based on a graph.

In this embodiment, because the constructed graph node can reflect an association relationship between different candidate entity words, the retrieval entity word can be first found in the graph based on the graph, and then an association degree of each candidate entity word relative to each retrieval entity word can be calculated.

In some embodiments, in the graph, based on a random walk algorithm by using a node representing each of these retrieval entity words as a start node, a probability measure of walking from the start node to each of other nodes can be calculated, and an association degree of a candidate entity word represented by each of the other nodes relative to each retrieval entity word can be determined based on the probability measure. For example, for a retrieval entity word, in the graph, based on the random walk algorithm by using a node representing the retrieval entity word as a start node, a probability measure of walking from the start node to each of other nodes can be calculated, and an association degree of a candidate entity word represented by each of the other nodes relative to the retrieval entity word can be determined based on the probability measure.

The random walk algorithm is a probability-based algorithm, is widely applied to a plurality of fields such as graph theory, statistical physics, and computer science, and describes a process of moving on a graph or another structure. Each step of moving is randomly selected. Based on different applications, random walk can be used to explore graphs, simulate physical processes, analyze network characteristics, etc.

In the random walk algorithm, for a given graph, starting from a certain start node, a neighboring node is randomly selected as a next destination based on a specific rule (usually a uniform distribution or weighted probability distribution). For each node in an undirected graph, if the node connects N edges, and there is no weight for the edge, a probability of moving from the node to any one of neighboring nodes of the node is 1/N. For each node in a directed graph, if the node has M outgoing edges, and there is no weight for the edge, a probability of moving from the node to any one of neighboring nodes of the node is 1/M. If there is a weight for the edge in the graph, the transition probability can be adjusted based on the weight for the edge. For example, a normalized weight can be used as the transition probability.

A walk stop condition of the random walk algorithm can be set as follows: The algorithm stops after a fixed quantity of steps, the algorithm can stop after walking through all possible nodes, or when the algorithm stops can be determined by using another specific condition.

Through the random walk algorithm, a probability distribution of each node in the graph in a stable state can be obtained, indicating a possibility of staying on each node starting from a start node.

In some embodiments, the random walk algorithm can be a PageRank algorithm or a personalized PageRank algorithm.

Step 506: Determine a predetermined quantity of candidate entity words with a highest association degree relative to the retrieval entity word as associated entity words, and calculate an association degree of each candidate document relative to the query text based on association degrees of the associated entity words relative to the retrieval entity word.

In this embodiment, the predetermined quantity (that is, top K) of candidate entity words with a highest association degree relative to the retrieval entity word can be determined as the associated entity words. For example, for a retrieval entity word, top K candidate entity words with a highest association degree relative to the retrieval entity word can be determined as associated entity words of the retrieval entity word.

When associated entity words of each retrieval entity word are determined, the association degree of each candidate document relative to the query text can be calculated based on an association degree of each associated entity word relative to each retrieval entity word. For example, a sum of association degrees of an associated entity word occurring in each candidate document relative to all retrieval entity words can be used as the association degree of the candidate document relative to the query text.

In some embodiments, for each candidate document, not only the association degree of the associated entity word occurring in the candidate document relative to the retrieval entity word affects the association degree of the candidate document relative to the query text, but also a quantity of occurrences of the associated entity word in the candidate document actually affects the association degree of the candidate document relative to the query text. Therefore, the association degree of the candidate document relative to the query text can be calculated based on an association degree of each associated entity word relative to each retrieval entity word and a quantity of occurrences of each associated entity word in the candidate document.

In some embodiments, each of the candidate documents can be sequentially determined as a target candidate document, and a product of an association degree of each associated entity word relative to the retrieval entity word and a quantity of occurrences of the associated entity word in the target candidate document can be first calculated as an association degree of the associated entity word relative to the query text. Subsequently, a sum of association degrees of all the associated entity words relative to the query text can be calculated as an association degree of the target candidate document relative to the query text.

For example, if there is a candidate document 1, a retrieval entity word A, a retrieval entity word B, a candidate entity word C, and a candidate entity word D, an association degree of the candidate entity word C relative to the retrieval entity word A is 0.9, an association degree of the candidate entity word C relative to the retrieval entity word B is 0.88, a quantity of occurrences of the candidate entity word C in the candidate document 1 is 15, an association degree of the candidate entity word D relative to the retrieval entity word A is 0.95, an association degree of the candidate entity word D relative to the retrieval entity word B is 0.55, and a quantity of occurrences of the candidate entity word D in the candidate document 1 is 10, there can be the following formula:
An association degree of the candidate entity word C relative to the query text is (0.9+0.88)/2*15=13.35 ((0.9+0.88)/2 is an average association degree of the candidate entity word C relative to all the retrieval entity words);
an association degree of the candidate entity word D relative to the query text is (0.95+0.55)/2*10=7.5 ((0.95+0.55)/2 is an average association degree of the candidate entity word D relative to all the retrieval entity words); and
an association degree of the candidate document 1 relative to the query text is 13.35+7.5=20.85.

Step 508: Determine a predetermined quantity of candidate documents with a highest association degree relative to the query text as associated documents, and determine the associated documents as an information retrieval result corresponding to the query text.

In this embodiment, when the association degree of each candidate document relative to the query text is calculated, the predetermined quantity (that is, top K) of candidate documents with a highest association degree relative to the query text can be determined as the associated documents, so that these associated documents can be determined as the information retrieval result corresponding to the query text. For example, these candidate documents can be ranked in descending order of association degrees relative to the query text, and top K candidate documents can be determined as the associated documents based on a ranking result.

Alternatively, the ranking result can be directly used as the information retrieval result corresponding to the query text. This is not specifically limited in this specification.

As described above, an intelligent dialogue system can provide a service to a user through RAG and with reference to information retrieval and model generation. In this case, the query text and the information retrieval result can be input into a large language model, so that the large language model performs inference based on the query text and the information retrieval result, to generate an answer text corresponding to the query text. For example, a prompt text used to stimulate the large language model to use the information retrieval result and context in the query text to execute a dialogue task can be constructed based on the query text and the information retrieval result, and the prompt text is input into the large language model, so that the large language model performs inference based on the query text and the information retrieval result under guidance of the prompt text, to generate the corresponding answer text.

In this case, the large language model can be a service model of the large language model, and the service model of the large language model is obtained by performing fine-tuning based on the dialogue task.

It should be noted that the large language model used to execute the dialogue task, the large language model used to perform named entity recognition, and the large language model used to extract the subject-predicate-object triple can be a same large language model, or can be different large language models. This is not specifically limited in this specification.

In the above embodiments, a graph used for information retrieval can be pre-constructed. Each node in the graph represents each candidate entity word, and each edge is used to indicate that there is an association relationship between candidate entity words represented by connected nodes. Subsequently, when a query text used to trigger information retrieval is obtained, named entity recognition can be first performed on the query text to recognize a retrieval entity word from the query text. Then, an association degree of each candidate entity word relative to the retrieval entity word can be calculated based on the constructed graph. Then, several candidate entity words with a highest association degree relative to the retrieval entity word can be determined as associated entity words, and an association degree of each candidate document relative to the query text can be calculated based on association degrees of the associated entity words relative to the retrieval entity word. Finally, several candidate documents with a highest association degree relative to the query text can be determined as associated documents, and the associated documents can be determined as an information retrieval result corresponding to the query text.

In the above manner, information retrieval is implemented with reference to a graph. Entity words in a retrievable document and an association relationship between the entity words can be captured by using the graph. Therefore, when a document is retrieved based on an entity word included in a query text, this can ensure that an information retrieval result is more accurate, and achieves stronger pertinence than an original query. In addition, the graph can be pre-constructed, so that the constructed graph can be directly used in a subsequent information retrieval process, to improve efficiency of implementing information retrieval with reference to the graph.

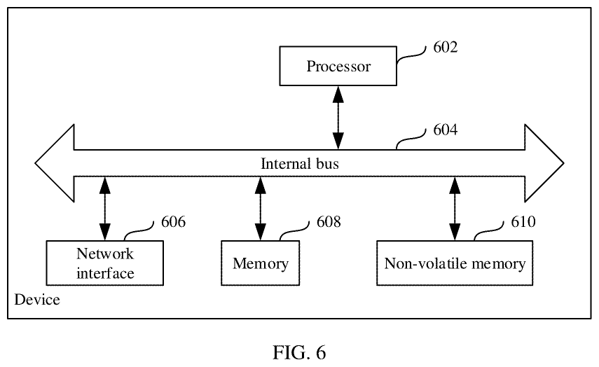

FIG. 6 is a schematic diagram of an information retrieval device according to an example embodiment. The device may include a processor 602, an internal bus 604, a network interface 606, a memory 608, and a non-volatile memory 610, and may further include other needed hardware. The processor 602 is configured to perform the information retrieval method described above. For example, the processor 602 reads a corresponding computer program from the non-volatile memory 610 to the memory 608, and then runs the computer program. The device can also be implemented with a logic device or a combination of software and hardware.

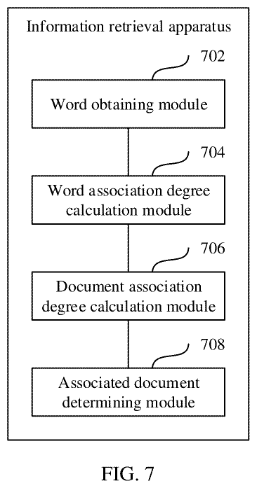

FIG. 7 is a block diagram of an information retrieval apparatus according to an example embodiment. The information retrieval apparatus can be applied to the device shown in FIG. 6, and includes: a word obtaining module 702, configured to: obtain a query text used to trigger information retrieval, perform named entity recognition on the query text to recognize an entity word from the query text, and determine the entity word recognized from the query text as a retrieval entity word; a word association degree calculation module 704, configured to calculate an association degree of each candidate entity word relative to the retrieval entity word based on a graph, where each node in the graph represents each candidate entity word, and there is an association relationship between candidate entity words represented by nodes connected by each edge in the graph; a document association degree calculation module 706, configured to: determine a predetermined quantity of candidate entity words with a highest association degree relative to the retrieval entity word as associated entity words, and calculate an association degree of each candidate document relative to the query text based on association degrees of the associated entity words relative to the retrieval entity word; and an associated document determining module 708, configured to: determine a predetermined quantity of candidate documents with a highest association degree relative to the query text as associated documents, and determine the associated documents as an information retrieval result corresponding to the query text.

In some embodiments, the apparatus further includes: a model generation module, configured to input the query text and the information retrieval result into a large language model, so that the large language model performs inference based on the query text and the information retrieval result, to generate an answer text corresponding to the query text.

In some embodiments, the apparatus further includes a graph construction module, configured to: obtain the candidate document, and perform named entity recognition on the candidate document to recognize an entity word from the candidate document; extract a subject-predicate-object triple from the candidate document based on the entity word recognized from the candidate document, and determine entity words in the subject-predicate-object triple as entity words with an association relationship; and determine the entity word recognized from the candidate document and the entity words in the subject-predicate-object triple as candidate entity words, and construct the graph based on the candidate entity words and an association relationship between the candidate entity words.

In some embodiments, the graph construction module is further configured to: calculate a similarity between each target candidate entity word and each of other candidate entity words in the candidate entity words, and determine a predetermined quantity of candidate entity words with a highest similarity as candidate entity words that have an association relationship with the target candidate entity word.

In some embodiments, a corresponding weight is set for each edge in the graph; a weight for an edge used to connect first-type nodes is a predetermined value, and a weight for an edge used to connect second-type nodes is a similarity between candidate entity words represented by the second-type nodes; candidate entity words represented by the first-type nodes are candidate entity words belonging to a same subject-predicate-object triple; and the candidate entity words represented by the second-type nodes are similar candidate entity words.

In some embodiments, the performing named entity recognition on the candidate document includes: inputting the candidate document into a large language model, so that the large language model performs named entity recognition on the candidate document; and the performing named entity recognition on the query text includes: inputting the query text into the large language model, so that the large language model performs named entity recognition on the query text.

In some embodiments, the extracting a subject-predicate-object triple from the candidate document based on the entity word recognized from the candidate document includes: inputting the entity word recognized from the candidate document and the candidate document into a large language model, so that the large language model extracts the subject-predicate-object triple from the candidate document based on the entity word recognized from the candidate document.

In some embodiments, the graph construction module is further configured to: count a quantity of occurrences of each candidate entity word in each candidate document, and store a correspondence between the candidate entity word, the candidate document, and the quantity of occurrences of the candidate entity word in the candidate document.

In some embodiments, the word obtaining module is further configured to: calculate a similarity between the entity word recognized from the query text and each candidate entity word, and determine a predetermined quantity of candidate entity words with a highest similarity as retrieval entity words.

In some embodiments, calculating a similarity between different entity words includes: performing embedding processing on each entity word to obtain an embedding vector corresponding to each entity word; and calculating a similarity between embedding vectors corresponding to the different entity words as the similarity between the different entity words.

In some embodiments, the calculating an association degree of each candidate entity word relative to the retrieval entity word based on a graph includes: calculating, in the graph based on a random walk algorithm by using a node representing the retrieval entity word as a start node, a probability measure of walking from the start node to each of other nodes, and determining, based on the probability measure, an association degree of a candidate entity word represented by each of the other nodes relative to the retrieval entity word.

In some embodiments, the calculating an association degree of each candidate document relative to the query text based on association degrees of the associated entity words relative to the retrieval entity word includes: calculating the association degree of each candidate document relative to the query text based on the association degrees of the associated entity words relative to the retrieval entity word and quantities of occurrences of the associated entity words in each candidate document.

In some embodiments, the calculating the association degree of each candidate document relative to the query text based on the association degrees of the associated entity words relative to the retrieval entity word and quantities of occurrences of the associated entity words in each candidate document includes: sequentially determining each of the candidate documents as a target candidate document, and calculating a product of an association degree of each associated entity word relative to the retrieval entity word and a quantity of occurrences of the associated entity word in the target candidate document as an association degree of the associated entity word relative to the query text; and calculating a sum of association degrees of all the associated entity words relative to the query text as an association degree of the target candidate document relative to the query text.

The apparatus embodiments basically correspond to the method embodiments. Therefore, for related parts, references can be made to partial descriptions in the method embodiments. The described apparatus embodiments are merely examples. The modules described as separate parts may or may not be physically separate, and parts displayed as modules may or may not be physical modules, that is, may be located at one location, or may be distributed on a plurality of network modules. Some or all of the modules can be selected based on actual requirements.

The system, apparatus, or module described in the above embodiments can be specifically implemented by a computer chip or entity, or can be implemented by a product having a certain function. The information retrieval device can be implemented with a personal computer, a laptop computer, a cellular phone, a camera phone, a smartphone, a personal digital assistant, a media player, a navigation device, an email receiving/sending device, a game console, a tablet computer, a wearable device, or a combination of any several of these devices.

Embodiments of this specification also provide a non-transitory computer-readable medium storing instructions that, when executed by a processor, cause the processor to perform the information retrieval method described above. Examples of the computer storage medium include but are not limited to a phase change random access memory (PRAM), a static random access memory (SRAM), a dynamic random access memory (DRAM), another type of random access memory (RAM), a read-only memory (ROM), an electrically erasable programmable read-only memory (EEPROM), a flash memory or another memory technology, a compact disc read-only memory (CD-ROM), a digital versatile disc (DVD), or another optical storage, a cassette, a disk memory, a quantum memory, a graphene-based storage medium, another magnetic storage device, or any other non-transmission medium. The computer storage medium can be configured to store information that can be accessed by a computing device. Based on the definition in this specification, the computer-readable medium does not include transitory media such as a modulated data signal and carrier.

In the embodiments of this specification, a graph used for information retrieval can be pre-constructed. Each node in the graph represents each candidate entity word, and each edge is used to indicate that there is an association relationship between candidate entity words represented by connected nodes. Subsequently, when a query text used to trigger information retrieval is obtained, named entity recognition can be first performed on the query text to recognize a retrieval entity word from the query text. Then, an association degree of each candidate entity word relative to the retrieval entity word can be calculated based on the constructed graph. Then, one or more candidate entity words with a highest association degree relative to the retrieval entity word can be determined as associated entity words, and an association degree of each candidate document relative to the query text can be calculated based on association degrees of the associated entity words relative to the retrieval entity word. Finally, several candidate documents with a highest association degree relative to the query text can be determined as associated documents, and the associated documents can be determined as an information retrieval result corresponding to the query text.

In the above manner, information retrieval is implemented with reference to a graph. Entity words in a retrievable document and an association relationship between the entity words can be captured by using the graph. Therefore, when a document is retrieved based on an entity word included in a query text, this can ensure that an information retrieval result is more accurate, and achieves stronger pertinence than an original query. In addition, the graph can be pre-constructed, so that the constructed graph can be directly used in a subsequent information retrieval process, to improve efficiency of implementing information retrieval with reference to the graph.

It should be noted that the terms “include”, “comprise”, or any other variants thereof are intended to cover a non-exclusive inclusion, so that a process, a method, or a device that includes a list of elements not only includes those elements but also includes other elements which are not expressly listed, or further includes elements inherent to such a process, method, or device. Without more constraints, an element preceded by “includes a . . . ” does not preclude the presence of additional identical elements in the process, method, product, or device that includes the element.

Example embodiments of this specification are described above. Other embodiments fall within the scope of this specification. In some cases, actions or steps described in the application can be performed in a sequence different from that in the embodiments and desired results can still be achieved. In addition, the process depicted in the accompanying drawings does not necessarily require a particular sequence or continuous sequence shown to achieve the expected results. In some implementations, multi-tasking and concurrent processing are feasible or may be advantageous.

Terms used in one or more embodiments of this specification are merely used to describe specific embodiments, and are not intended to limit the embodiments. The terms “a” and “the” of singular forms are also intended to include plural forms, unless otherwise specified in the context clearly. The term “and/or” indicates and includes any or all possible combinations of one or more associated listed items.

Descriptions of the terms “one embodiment”, “some embodiments”, “example”, “specific example”, or “one implementation” used in this specification mean that a specific feature or characteristic described with reference to the embodiment(s) is included in at least one embodiment of this specification, not necessarily with respect to a same embodiment. In addition, the described specific feature or characteristic can be combined in a proper manner in one or more embodiments of this specification. In addition, without contradicting each other, different embodiments and specific features or characteristics in the different embodiments can be combined.

It should be understood that although terms “first”, “second”, “third”, etc. may be used in one or more embodiments of this specification to describe various types of information, the information is not limited to these terms. These terms are merely used to distinguish between information of a same type. For example, without departing from the scope of one or more embodiments of this specification, first information can also be referred to as second information, and similarly, the second information can be referred to as the first information. Depending on the context, for example, the word “if” used herein can be explained as “while”, “when”, or “in response to determining”.

The above descriptions are merely example embodiments of this specification, but are not intended to limit the embodiments of this specification. Any modification, equivalent replacement, improvement, etc. made without departing from the spirit and principle of the one or more embodiments of this specification shall fall within the protection scope of the one or more embodiments of this specification.

User information (including but not limited to user equipment information, personal user information, etc.) and data (including but not limited to data used for analysis, stored data, displayed data, etc.) in this specification are information and data that are authorized by a user or that are fully authorized by each party. Furthermore, related data needs to be collected, used, and processed in compliance with relevant laws, regulations and standards of relevant countries and regions, and corresponding operation entries are provided for the user to choose to authorize or reject.

1. An information retrieval method, comprising:
obtaining a query text used to trigger information retrieval, performing named entity recognition on the query text to recognize an entity word from the query text, and determining the entity word recognized from the query text as a retrieval entity word;
calculating an association degree of each candidate entity word relative to the retrieval entity word based on a graph, wherein each node in the graph represents each candidate entity word, and there is an association relationship between candidate entity words represented by nodes connected by each edge in the graph;
determining a predetermined quantity of candidate entity words with a highest association degree relative to the retrieval entity word as associated entity words, and calculating an association degree of each candidate document relative to the query text based on association degrees of the associated entity words relative to the retrieval entity word; and
determining a predetermined quantity of candidate documents with a highest association degree relative to the query text as associated documents, and determining the associated documents as an information retrieval result corresponding to the query text.

2. The method according to claim 1, further comprising:
inputting the query text and the information retrieval result into a large language model, wherein the large language model performs inference based on the query text and the information retrieval result, to generate an answer text corresponding to the query text.

3. The method according to claim 1, further comprising:
obtaining a candidate document, and performing named entity recognition on the candidate document to recognize an entity word from the candidate document;
extracting a subject-predicate-object triple from the candidate document based on the entity word recognized from the candidate document, and determining entity words in the subject-predicate-object triple as entity words with an association relationship; and
determining the entity word recognized from the candidate document and the entity words in the subject-predicate-object triple as candidate entity words, and constructing the graph based on the candidate entity words and an association relationship between the candidate entity words.

4. The method according to claim 3, further comprising:
calculating a similarity between each target candidate entity word and each of other candidate entity words in the candidate entity words, and determining a predetermined quantity of candidate entity words with a highest similarity as candidate entity words that have an association relationship with the target candidate entity word.

5. The method according to claim 4, wherein a corresponding weight is set for each edge in the graph; a weight for an edge used to connect first-type nodes is a predetermined value, and a weight for an edge used to connect second-type nodes is a similarity between candidate entity words represented by the second-type nodes; candidate entity words represented by the first-type nodes are candidate entity words belonging to a same subject-predicate-object triple; and the candidate entity words represented by the second-type nodes are similar candidate entity words.

6. The method according to claim 3, wherein the performing named entity recognition on the candidate document comprises:
inputting the candidate document into a large language model, wherein the large language model performs named entity recognition on the candidate document; and
the performing named entity recognition on the query text comprises:
inputting the query text into the large language model, wherein the large language model performs named entity recognition on the query text.

7. The method according to claim 3, wherein the extracting the subject-predicate-object triple from the candidate document based on the entity word recognized from the candidate document comprises:
inputting the entity word recognized from the candidate document and the candidate document into a large language model, wherein the large language model extracts the subject-predicate-object triple from the candidate document based on the entity word recognized from the candidate document.

8. The method according to claim 3, further comprising:
counting a quantity of occurrences of each candidate entity word in each candidate document, and storing a correspondence between the candidate entity word, the candidate document, and the quantity of occurrences of the candidate entity word in the candidate document.

9. The method according to claim 4, further comprising:
calculating a similarity between the entity word recognized from the query text and each candidate entity word, and determining a predetermined quantity of candidate entity words with a highest similarity as retrieval entity words.

10. The method according to claim 9, wherein calculating the similarity between different entity words comprises:
performing embedding processing on each entity word to obtain an embedding vector corresponding to each entity word; and
calculating a similarity between embedding vectors corresponding to the different entity words as the similarity between the different entity words.

11. The method according to claim 1, wherein the calculating the association degree of each candidate entity word relative to the retrieval entity word based on the graph comprises:
calculating, in the graph based on a random walk algorithm by using a node representing the retrieval entity word as a start node, a probability measure of walking from the start node to each of other nodes, and determining, based on the probability measure, an association degree of a candidate entity word represented by each of the other nodes relative to the retrieval entity word.

12. The method according to claim 1, wherein the calculating the association degree of each candidate document relative to the query text based on association degrees of the associated entity words relative to the retrieval entity word comprises:
calculating the association degree of each candidate document relative to the query text based on the association degrees of the associated entity words relative to the retrieval entity word and quantities of occurrences of the associated entity words in each candidate document.

13. The method according to claim 12, wherein the calculating the association degree of each candidate document relative to the query text based on the association degrees of the associated entity words relative to the retrieval entity word and quantities of occurrences of the associated entity words in each candidate document comprises:
sequentially determining each of the candidate documents as a target candidate document, and calculating a product of an association degree of each associated entity word relative to the retrieval entity word and a quantity of occurrences of the associated entity word in the target candidate document as an association degree of the associated entity word relative to the query text; and
calculating a sum of association degrees of all the associated entity words relative to the query text as an association degree of the target candidate document relative to the query text.

14. An electronic device, comprising:
a processor; and
a storage, configured to store processor-executable instructions,
wherein the processor is configured to:
obtain a query text used to trigger information retrieval, perform named entity recognition on the query text to recognize an entity word from the query text, and determine the entity word recognized from the query text as a retrieval entity word;
calculate an association degree of each candidate entity word relative to the retrieval entity word based on a graph, wherein each node in the graph represents each candidate entity word, and there is an association relationship between candidate entity words represented by nodes connected by each edge in the graph;
determine a predetermined quantity of candidate entity words with a highest association degree relative to the retrieval entity word as associated entity words, and calculate an association degree of each candidate document relative to the query text based on association degrees of the associated entity words relative to the retrieval entity word; and
determine a predetermined quantity of candidate documents with a highest association degree relative to the query text as associated documents, and determine the associated documents as an information retrieval result corresponding to the query text.

15. The electronic device according to claim 14, wherein the processor is further configured to:
input the query text and the information retrieval result into a large language model, wherein the large language model performs inference based on the query text and the information retrieval result, to generate an answer text corresponding to the query text.

16. The electronic device according to claim 14, wherein the processor is further configured to:
obtain a candidate document, and perform named entity recognition on the candidate document to recognize an entity word from the candidate document;
extract a subject-predicate-object triple from the candidate document based on the entity word recognized from the candidate document, and determine entity words in the subject-predicate-object triple as entity words with an association relationship; and
determine the entity word recognized from the candidate document and the entity words in the subject-predicate-object triple as candidate entity words, and construct the graph based on the candidate entity words and an association relationship between the candidate entity words.

17. The electronic device according to claim 16, wherein the processor is further configured to:
calculate a similarity between each target candidate entity word and each of other candidate entity words in the candidate entity words, and determine a predetermined quantity of candidate entity words with a highest similarity as candidate entity words that have an association relationship with the target candidate entity word.

18. The electronic device according to claim 17, wherein a corresponding weight is set for each edge in the graph; a weight for an edge used to connect first-type nodes is a predetermined value, and a weight for an edge used to connect second-type nodes is a similarity between candidate entity words represented by the second-type nodes; candidate entity words represented by the first-type nodes are candidate entity words belonging to a same subject-predicate-object triple; and the candidate entity words represented by the second-type nodes are similar candidate entity words.

19. The electronic device according to claim 16, wherein the processor is further configured to:
input the candidate document into a large language model, wherein the large language model performs named entity recognition on the candidate document; and
input the query text into the large language model, wherein the large language model performs named entity recognition on the query text.

20. A non-transitory computer-readable storage medium storing instructions that, when executed by a processor, cause the processor to perform an information retrieval method, the method comprising:
obtaining a query text used to trigger information retrieval, performing named entity recognition on the query text to recognize an entity word from the query text, and determining the entity word recognized from the query text as a retrieval entity word;
calculating an association degree of each candidate entity word relative to the retrieval entity word based on a graph, wherein each node in the graph represents each candidate entity word, and there is an association relationship between candidate entity words represented by nodes connected by each edge in the graph;
determining a predetermined quantity of candidate entity words with a highest association degree relative to the retrieval entity word as associated entity words, and calculating an association degree of each candidate document relative to the query text based on association degrees of the associated entity words relative to the retrieval entity word; and
determining a predetermined quantity of candidate documents with a highest association degree relative to the query text as associated documents, and determining the associated documents as an information retrieval result corresponding to the query text.
